(19) United States
(12) Patent Application Publication
(10) Pub. No.: US 2012/0144443 A1
(43) Pub. Date: Jun. 7, 2012

(54) SYSTEM AND METHOD FOR EXECUTING SOURCE BUFFERING FOR MULTIPLE INDEPENDENT GROUP TRANSMISSION OF REAL-TIME ENCODED SCALABE VIDEO CONTENTS

(75) Inventors: Seong Jun BAE, Daejeon (KR); Jung Won KANG, Seoul (KR); Jeong Yeon LIM, Seongnam-si (KR); Jin Han SONG, Seoul (KR)

(73) Assignees: SK Telecom Co., Ltd., Seoul (KR); Electronics and Telecommunications Research Institute, Daejeon (KR)

(21) Appl. No.: 13/252,758

(22) Filed: Oct. 4, 2011

(30) Foreign Application Priority Data
Oct. 6, 2010 (KR) 10-2010-0097166
Dec. 22, 2010 (KR) 10-2010-0132533

(51) Int. Cl. H04N 21/27

(52) U.S. Cl. 725/110; 725/109

(57) ABSTRACT

A system and method for performing source buffering to transmit a real-time encoded scalable video to multiple transmission groups are provided. A streaming system for providing a scalable video bitstream for each multicast group may include an encoder source buffer to receive a scalable video bitstream and to store the received scalable video bitstream, and a plurality of subgroup transmitters, each to receive data of different layers in the stored scalable video bitstream from the encoder source buffer, to packetize the received data, and to transmit the packetized data to a terminal.

### TECHNICAL FIELD

Embodiments of the present invention relate to a system and method for performing source buffering to transmit a real-time encoded scalable video to multiple transmission groups.

### BACKGROUND ART

A scalable video encoding technology may remove mutually redundant data from video data with various resolutions, various frame rates, and various image qualities, may encode the video data to a single video content, may generate an integrated video bitstream with only a video content capacity corresponding to a maximum resolution, a maximum frame rate, and a maximum image quality, and may extract only as much data as needed, corresponding to a used scenario, from the integrated video bitstream, so that various resolutions, various frame rates, and various image qualities may be supported by only a single bitstream.

Such a scalable video bitstream may support various resolutions, various frame rates, and various image qualities, using a hierarchical structure of a bitstream. To support various resolutions, various frame rates, and various image qualities, the scalable video bitstream may be configured by adding data of a layer corresponding to an additional resolution to a basic resolution layer, or by adding data of a layer corresponding to an additional frame rate to a basic frame rate layer, and data of a corresponding layer level may be extracted.

When the scalable video bitstream is used, various image quality levels may be serviced through at least two multicast addresses. Specifically, a single bitstream may be divided into layers that are transmitted to at least two multicast groups, and different image quality levels corresponding to a number of multicast groups may be provided.

When a file is used as an entire bitstream source for a multicast service, a transmitting end of each multicast group may freely access all portions of the file independently to read a portion of the file that is needed to be transmitted.

However, when a real-time encoder is used as an entire bitstream source for a multicast service, there is no bitstream data that enables freely accessing all the portions of the file, and only a bitstream corresponding to a specific time period that is encoded and output by the real-time encoder may be used.

When a streaming server transmits a bitstream with different layers for each multicast group, each multicast group independently requires data corresponding to each of the layers. Here, to receive an input bitstream required by each multicast group, the streaming server needs to store the entire bitstream received from the real-time encoder for a specific period. To store the entire bitstream for the specific period, additional buffering may be required, unlike streaming of a video bitstream in which there is no existing layer level.

The additional buffering may lead to an additional encoding delay time, which may result in a serious problem of causing an entire service delay time in a real-time broadcasting service utilizing multicast.

### DISCLOSURE OF THE INVENTION

### Subjects to be Solved by the Invention

An aspect of embodiments of the present invention is to reduce buffering delay between a real-time encoder and a streaming server, when the streaming server streams, to at least two transmission groups, a video stream that is real-time encoded and that is being received from a scalable video encoder.

### Solutions to Solve the Subjects

According to an aspect of the present invention, there is provided a streaming system for providing a scalable video bitstream for each multicast group, including: an encoder source buffer to receive a scalable video bitstream and to store the received scalable video bitstream; and a plurality of subgroup transmitters, each to receive data of different layers in the stored scalable video bitstream from the encoder source buffer, to packetize the received data, and to transmit the packetized data to a terminal.

The encoder source buffer may store the data of the different layers in the scalable video bitstream, in an order of frames, and in an order from a lowest layer to a highest layer.

Each of the plurality of subgroup transmitters may extract data of a required layer from the encoder source buffer, based on a playback time, and may store the extracted data.

Each of the plurality of subgroup transmitters may transmit the packetized data to a subgroup receiver that receives data of layers corresponding to the packetized data, among a plurality of subgroup receivers included in the terminal.

According to another aspect of the present invention, there is provided a terminal system for receiving a scalable video bitstream for each multicast group, including: a plurality of subgroup receivers, each to receive, from a streaming server, data of a corresponding layer among data of layers in a scalable video bitstream; and a decoder to decode data received from the plurality of subgroup receivers, wherein the data of the layers is divided for each of the layers, when a plurality of subgroup transmitters each extract the data of the layers from an encoder source buffer and buffer the extracted data, wherein the subgroup transmitters and the encoder source buffer are included in the streaming server, and wherein each of the plurality of subgroup receivers receives data of a required layer from a subgroup transmitter that buffers the data of the required layer among the plurality of subgroup transmitters.

According to still another aspect of the present invention, there is provided a real-time encoding system for generating a scalable video bitstream, including: a bitstream generator to generate a scalable video bitstream; and a bitstream transmitter to transmit the generated scalable video bitstream to a streaming server, wherein data of layers in the scalable video bitstream is stored in an encoder source buffer included in the streaming server, in an order of frames, and in an order from a lowest layer to a highest layer.

According to yet another aspect of the present invention, there is provided a bitstream transmission method for providing a scalable video bitstream for each multicast group, including: receiving a scalable video bitstream and storing the received scalable video bitstream in an encoder source buffer; and receiving data of different layers in the stored scalable video bitstream from the encoder source buffer, packetizing the received data, and transmitting the packetized data to a terminal.

According to a further aspect of the present invention, there is provided a bitstream transmission method for receiving a scalable video bitstream for each multicast group, including: receiving, from a streaming server, data of a corresponding layer among data of layers in a scalable video bitstream; and decoding the received data, wherein the data of the layers is divided for each of the layers, when a plurality of subgroup transmitters each extract the data of the layers from an encoder source buffer and buffer the extracted data, wherein the subgroup transmitters and the encoder source buffer are included in the streaming server, and wherein the receiving includes receiving data of a required layer from a subgroup transmitter that buffers the data of the required layer among the plurality of subgroup transmitters.

According to a further aspect of the present invention, there is provided a bitstream transmission method for generating a scalable video bitstream, including: generating a scalable video bitstream; and transmitting the generated scalable video bitstream to a streaming server, wherein data of layers in the scalable video bitstream is stored in an encoder source buffer included in the streaming server, in an order of frames, and in an order from a lowest layer to a highest layer.

### Effect of the Invention

According to embodiments of the present invention, it is possible to transmit data of various layers for each multicast group, using an encoder source buffer.

Additionally, according to embodiments of the present invention, it is possible to minimize a size of a real-time encoder input bitstream buffer (hereinafter, referred to as an encoder source buffer) that is used to transmit independent bitstream layers of a multicast group in a multicast scenario using scalable video bitstreaming.

### BRIEF DESCRIPTION OF THE DRAWING

FIG. 1 is a diagram illustrating a structure of a scalable video bitstream, according to an embodiment of the present invention.

FIG. 2 is a diagram illustrating a method of packetizing a scalable video bitstream, according to an embodiment of the present invention.

FIG. 3 is a diagram illustrating a system for dividing a scalable video bitstream into at least two multicast groups and transmitting the scalable video bitstream, according to an embodiment of the present invention.

FIG. 4 is a diagram illustrating an example of performing a playback time-based buffering in a system for dividing a scalable video bitstream into at least two multicast groups and transmitting the scalable video bitstream, according to an embodiment of the present invention.

FIG. 5 is a block diagram illustrating a configuration of a streaming server, according to an embodiment of the present invention.

FIG. 6 is a block diagram illustrating a configuration of a terminal system, according to an embodiment of the present invention.

FIG. 7 is a flowchart illustrating a method of transmitting a scalable video bitstream, according to an embodiment of the present invention.

### DETAILED DESCRIPTION FOR CARRYING OUT THE INVENTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

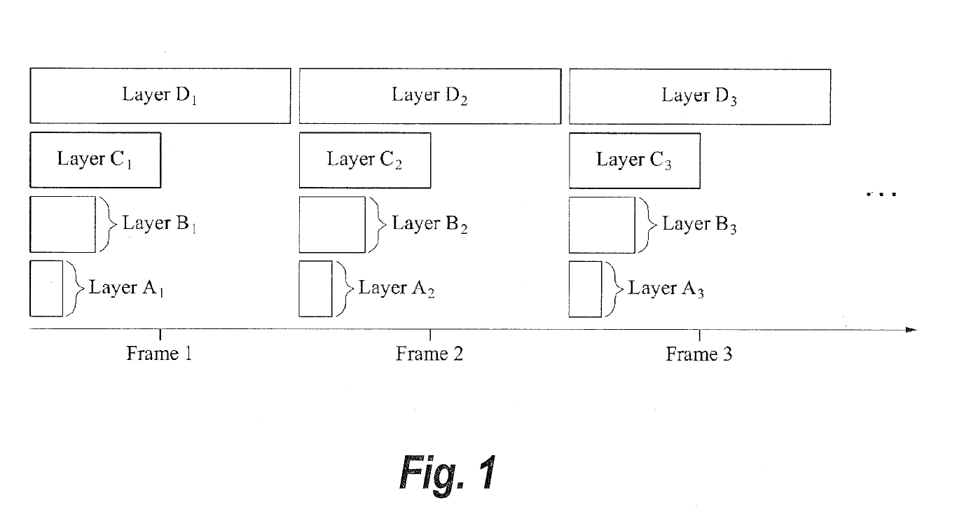

FIG. 1 is a diagram illustrating a structure of a scalable video bitstream according to an embodiment of the present invention. FIG. 1 shows a general structure of a scalable video bitstream. The scalable video bitstream may include layers corresponding to additional data based on each image quality level. As shown in FIG. 1, the scalable video bitstream includes four layers. A unit represented by a single box refers to a data unit corresponding to a single layer in a single frame. Additionally, data corresponding to layers of FIG. 1 may differ from each other in size. Data of layer A has a lowest size, and a size of data may be increased in an order of layers B, C, and D. In other words, data may actually have different sizes for each of the layers in the scalable video bitstream.

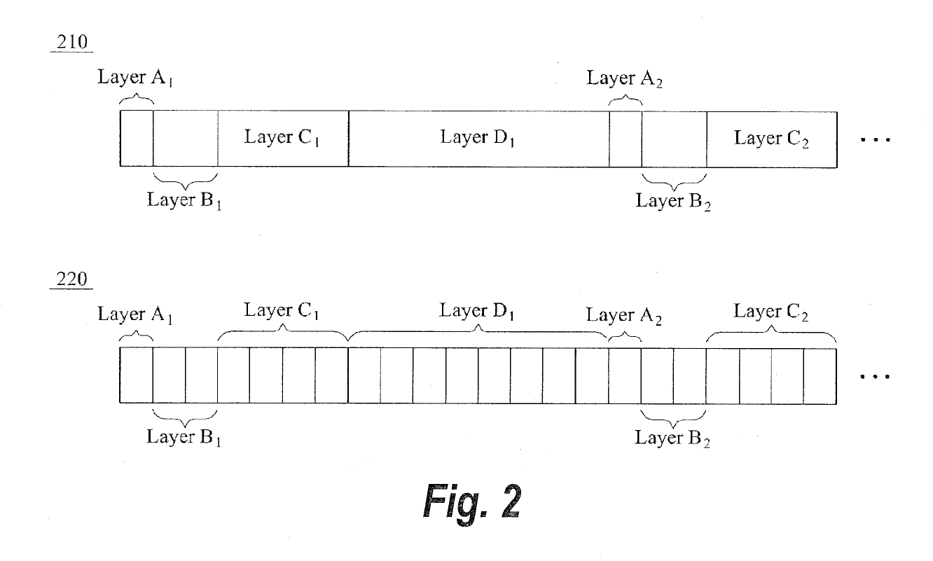

FIG. 2 is a diagram illustrating a method of packetizing a scalable video bitstream according to an embodiment of the present invention.

In a first data structure 210, a single scalable video bitstream may include, for example, data of FIG. 1. The scalable video bitstream may be stored in an order of frames, and in an order from a lowest layer to a highest layer, in a manner in which a single frame is stored and a next frame is then stored. A decoder or a streaming server may actually identify which layer corresponding to data includes a layer unit in each frame, using three identifiers included in each layer unit, for example, a spatial ID, a temporal ID, and a quality ID.

In a second data structure 220, a scalable video bitstream formed in the same order as shown in the first data structure 210 is actually packetized. In an example of a scalable video bitstream higher than a High Definition (HD) level, a single layer unit is much larger than a size of a single packet in an Internet Protocol (IP) network. Accordingly, the scalable video bitstream may be divided by a Maximum Transfer Unit (MTU) of an IP packet. In other words, a layer unit in each frame of the scalable video bitstream may be divided into different numbers of IP packets, for each layer.

For example, ‘Layer A₁’ in the second data structure 220 is divided into a single packet. However, a size of a packet into which each layer unit is divided may vary depending on a size of a layer unit.

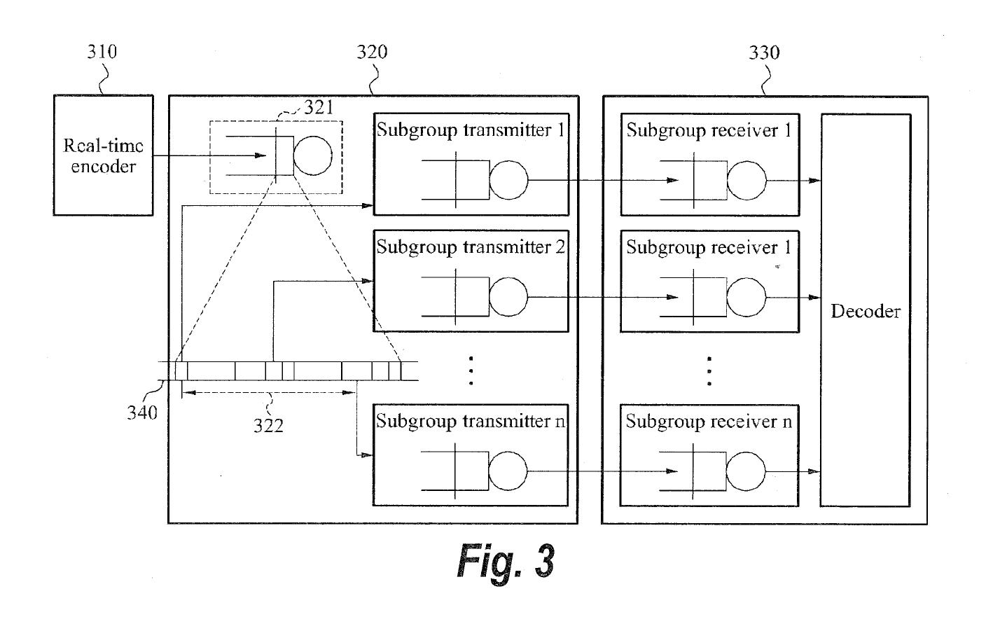

FIG. 3 is a diagram illustrating a system for dividing a scalable video bitstream into at least two multicast groups and transmitting the scalable video bitstream according to an embodiment of the present invention. FIG. 3 illustrates a real-time encoder 310, a streaming server 320, and a terminal 330. The streaming server 320 may include an encoder source buffer 321, and ‘n’ subgroup transmitters. As indicated by reference numeral 340 in FIG. 3, an actual transmission sequence of a scalable video bitstream stored in the encoder source buffer 321 may be extended.

When the scalable video bitstream is transmitted from the real-time encoder 310 to the streaming server 320, the encoder source buffer 321 in the streaming server 320 may receive the scalable video bitstream. The subgroup transmitters included in the streaming server 320 may each transmit, to the terminal 330, layers in the scalable video bitstream for each multicast group. The subgroup transmitters may each perform IP packetizing on the layers, and may operate packet buffers of the subgroup transmitters, to transmit packets. The IP packetizing may be understood with reference to FIG. 2. Additionally, the subgroup transmitters may independently access the encoder source buffer 321, and may receive data of required layers. Accordingly, the encoder source buffer 321 needs to verify that the subgroup transmitters do not require buffered bitstream data any more, before deleting the buffered bitstream data.

FIG. 3 also shows an operation of the encoder source buffer 321 in an example in which each of the subgroup transmitters performs an existing buffering scheme, namely, a data size-based buffering. The actual transmission sequence of the scalable video bitstream stored in the encoder source buffer 321 may be extended, as indicated by reference numeral 340 in FIG. 3. For example, when each of the subgroup transmitters performs the data size-based buffering, each of the packet buffers may buffer a number of specific packets, to prevent underflow during transmission of packets. However, in this example, the subgroup transmitters may each packetize different layers in the scalable video bitstream, and data of the different layers may have different sizes. Accordingly, in the same time period, a scalable video bitstream required by each of the subgroup transmitters may be distributed. For example, a subgroup transmitter 1 including data with a low level layer may require data occurring significantly later in time, whereas a subgroup transmitter ‘n’ including data with a high level layer may require data occurring earlier in time. In other words, the encoder source buffer 321 that supplies data to all the subgroup transmitters may need to store data over a very wide time period, which may result in an increase in a buffering period 322, namely, lengthening a buffering delay time.

According to another embodiment of the present invention, each of the subgroup transmitters may perform playback time-based buffering, instead of the data size-based buffering.

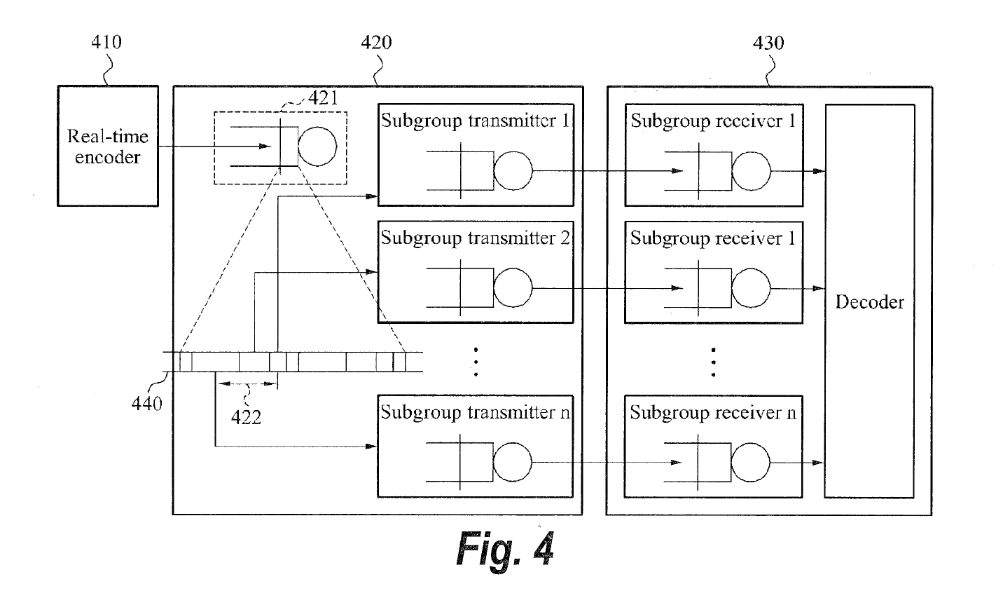

FIG. 4 is a diagram illustrating an example of performing playback time-based buffering in a system for dividing a scalable video bitstream into at least two multicast groups and transmitting the scalable video bitstream, according to an embodiment of the present invention. FIG. 4 illustrates a real-time encoder 410, a streaming server 420, and a terminal 430. Specifically, FIG. 4 illustrates an operation of an encoder source buffer 421 in an example in which the playback time-based buffering is performed. Each of subgroup transmitters may calculate how much time may be played by a packet buffered in a packet buffer operated by each of the subgroup transmitters, while receiving bitstream data from the encoder source buffer 421. Here, all of the subgroup transmitters may buffer a same playback time period as a time difference between playback times of packets that are currently transmitted by the subgroup transmitters, and accordingly a portion required by the encoder source buffer 421 may also be matched to a portion corresponding to the same playback time. As illustrated in FIG. 4, a required buffering period 422 is much shorter than the buffering period 322 required in the data size-based buffering. Actually, a bitstream period required by each of the subgroup transmitters may be within the same video frame data and accordingly, the encoder source buffer 421 may reduce an amount of encoder source buffering to data corresponding to at least one frame.

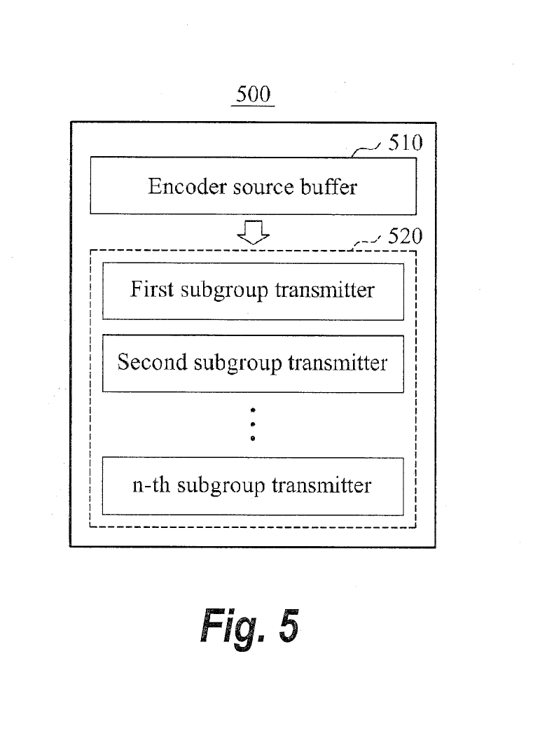

FIG. 5 is a block diagram illustrating a configuration of a streaming server according to an embodiment of the present invention. A streaming system 500 may correspond to the streaming server 320 of FIG. 3, or the streaming server 420 of FIG. 4. To provide a scalable video bitstream for each multicast group, the streaming system 500 may include an encoder source buffer 510, and a plurality of subgroup transmitters 520, as illustrated in FIG. 5.

The encoder source buffer 510 may receive a scalable video bitstream from a real-time encoder, and may store the received scalable video bitstream. Specifically, the encoder source buffer 510 may store data of different layers in the scalable video bitstream, in an order of frames, and in an order from a lowest layer to a highest layer.

The plurality of subgroup transmitters 520 may each receive, from the encoder source buffer 510, the data of the different layers in the stored scalable video bitstream, may packetize the received data, and may transmit the packetized data to a terminal.

The packetized data may be transmitted to a subgroup receiver that receives data of a corresponding layer, among a plurality of subgroup receivers included in the terminal. Data of layers, respectively transmitted from the subgroup transmitters 520 to the subgroup receivers, may also be included in a bitstream. Here, the bitstream may include data of a single layer, whereas the scalable video bitstream received from the real-time encoder may include data of at least two layers.

The streaming system 500 may enable each of the subgroup transmitters 520 to access predetermined data and receive the predetermined data, using the encoder source buffer 510. Here, each of the subgroup transmitters 520 may receive data of a corresponding layer, and may transmit the received data. In other words, when the encoder source buffer 510 is not used, it may be difficult for the subgroup transmitters 520 to access predetermined data in the scalable video bitstream received from the real-time encoder. However, using of the encoder source buffer 510 may enable accessing predetermined data and receiving the predetermined data.

Additionally, the subgroup transmitters 520 may perform the playback time-based buffering, as well as, the data size-based buffering. As described with reference to FIG. 1, data of layer units included in the scalable video bitstream may have different sizes for the same playback time (for example, the same frame), and accordingly when the data size-based buffering is performed, the encoder source buffer 510 that supplies data to the subgroup transmitters 520 needs to store data over a very wide time period, which may result in an increase in a buffering period, namely, lengthening of a buffering delay time. Here, when the subgroup transmitters 520 each receive data from the encoder source buffer 510 based on the playback time by performing the playback time-based buffering, data with different sizes for each layer in a single frame may be simultaneously transmitted to the subgroup transmitters 520 and thus, the buffering period may be shortened, compared to the data size-based buffering. In other words, the buffering delay time may be reduced.

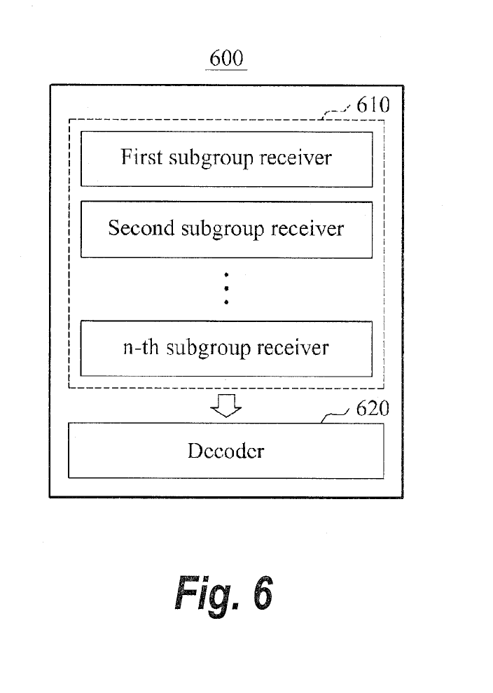

FIG. 6 is a block diagram illustrating a configuration of a terminal system according to an embodiment of the present invention. A terminal system 600 may correspond to the terminal 330 of FIG. 3, the terminal 430 of FIG. 4, or the terminal of FIG. 5. As illustrated in FIG. 6, the terminal system 600 may include a plurality of subgroup receivers 610, and a decoder 620.

The plurality of subgroup receivers 610 may each receive, from a streaming server, data of a corresponding layer among data of different layers in a scalable video bitstream. Here, the streaming server may correspond to the streaming server 320 of FIG. 3, the streaming server 420 of FIG. 4, or the streaming system 500 of FIG. 5.

The decoder 620 may decode the data received from the subgroup receivers 610.

The data of the layers may be divided for each of the layers, when a plurality of subgroup transmitters each extract the data of the layers from an encoder source buffer, and buffer the extracted data. Here, the subgroup transmitters, and the encoder source buffer may be included in the streaming server. Each of the plurality of subgroup receivers 610 may receive data of a required layer from a subgroup transmitter that buffers the data of the required layer among the subgroup transmitters. For example, a subgroup receiver used to receive data of layer A of FIG. 1 may receive the data of layer A through a subgroup transmitter that receives the data of layer A from the encoder source buffer. Here, the encoder source buffer may buffer the scalable video bitstream received from a real-time encoder, and the subgroup transmitters may each packetize data stored in buffers of the subgroup transmitters.

Accordingly, the decoder 620 may decode data of different layer levels transmitted from the subgroup receivers 610 that receive data by layer units. The terminal system 600 may provide a user with video having various resolutions, various frame rates, and various image qualities.

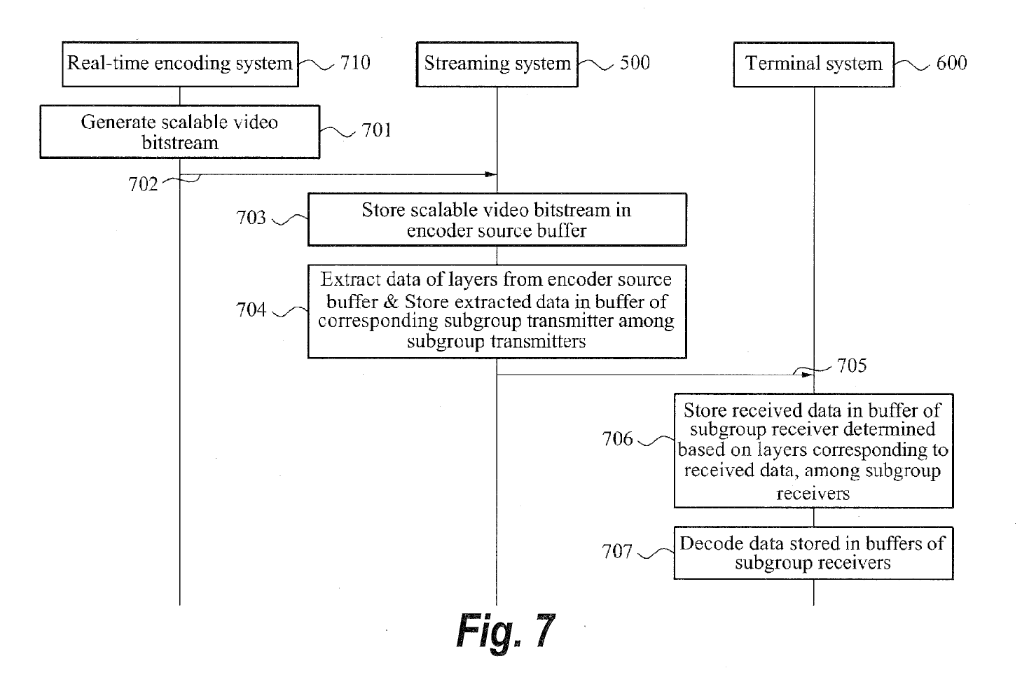

FIG. 7 is a flowchart illustrating a method of transmitting a scalable video bitstream according to an embodiment of the present invention. FIG. 7 illustrates a real-time encoding system 710, the streaming system 500 of FIG. 5, and the terminal system 600 of FIG. 6. The real-time encoding system 710 may correspond to the real-time encoder 310 of FIG. 3, the real-time encoder 410 of FIG. 4, or the real-time encoder of FIG. 5 or 6.

In operation 701, the real-time encoding system 710 may generate a scalable video bitstream. In operation 702, the real-time encoding system 710 may transmit the generated scalable video bitstream to the streaming system 500. Additionally, in operation 720, the streaming system 500 may receive the scalable video bitstream from the real-time encoding system 710.

In operation 703, the streaming system 500 may store the received scalable video bitstream in the encoder source buffer. In operation 704, the streaming system 500 may extract data of layers from the encoder source buffer, and may store the extracted data in a buffer of a corresponding subgroup transmitter among a plurality of subgroup transmitters. Actually, the subgroup transmitters included in the streaming system 500 may each receive data of a corresponding layer from the encoder source buffer, and may store the received data in buffers of the subgroup transmitters.

In operation 705, the streaming system 500, or each of the subgroup transmitters may packetize the data stored in the buffers of the subgroup transmitters, and may transmit the packetized data to the terminal system 600. Additionally, in operation 705, the terminal system 600 may receive the packetized data from the streaming system 500.

In operation 706, the terminal system 600 may store the received data in a buffer of a subgroup receiver determined based on layers corresponding to the received data, among the plurality of subgroup receivers. In operation 707, the terminal system 707 may decode data stored in buffers of the subgroup receivers.

Here, the subgroup transmitters may each extract, from the encoder source buffer, data of a corresponding layer, based on a data size or based on a playback time, and may store the extracted data in the buffers of the subgroup transmitters.

As described above, according to embodiments of the present invention, it is possible to transmit data of various layers for each multicast group, using an encoder source buffer. Additionally, it is possible to minimize a size of a real-time encoder input bitstream buffer (namely, an encoder source buffer) that is used to transmit independent bitstream layers of a multicast group in a multicast scenario using scalable video bitstreaming.

The embodiments of the present invention may be recorded in computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

### EXPLANATION OF REFERENCE NUMERALS

310, 410: Real-time encoder
320, 420: Streaming server
321, 421: Encoder source buffer
330, 430: Terminal

1. A streaming system for providing a scalable video bitstream for each multicast group, the streaming system comprising:
an encoder source buffer to receive a scalable video bitstream and to store the received scalable video bitstream; and
a plurality of subgroup transmitters, each to receive data of different layers in the stored scalable video bitstream from the encoder source buffer, to packetize the received data, and to transmit the packetized data to a terminal.

2. The streaming system of claim 1, wherein the encoder source buffer stores the data of the different layers in the scalable video bitstream, in an order of frames, and in an order from a lowest layer to a highest layer.

3. The streaming system of claim 1, wherein each of the plurality of subgroup transmitters extracts data of a required layer from the encoder source buffer, based on a playback time, and stores the extracted data.

4. The streaming system of claim 1, wherein each of the plurality of subgroup transmitters transmits the packetized data to a subgroup receiver that receives data of layers corresponding to the packetized data, among a plurality of subgroup receivers included in the terminal.

5. A terminal system for receiving a scalable video bitstream for each multicast group, the terminal system comprising:
a plurality of subgroup receivers, each to receive, from a streaming server, data of a corresponding layer among data of layers in a scalable video bitstream; and
a decoder to decode data received from the plurality of subgroup receivers,
wherein the data of the layers is divided for each of the layers, when a plurality of subgroup transmitters each extract the data of the layers from an encoder source buffer and buffer the extracted data, wherein the subgroup transmitters and the encoder source buffer are included in the streaming server, and
wherein each of the plurality of subgroup receivers receives data of a required layer from a subgroup transmitter that buffers the data of the required layer among the plurality of subgroup transmitters.

6. The terminal system of claim 5, wherein the data of the layers is extracted from the encoder source buffer based on a playback time, and the extracted data is stored in a buffer of a corresponding subgroup transmitter.

7. The terminal system of claim 5, wherein the scalable video bitstream is generated by a real-time encoder, is transmitted to the streaming server, and is stored in the encoder source buffer in an order of frames, and in an order from a lowest layer to a highest layer.

8. The terminal system of claim 5, wherein the decoder decodes data of different layers received from the plurality of subgroup receivers, and generates videos that differ from each other in at least one of a resolution, a frame rate, and an image quality.

9. A real-time encoding system for generating a scalable video bitstream, the real-time encoding system comprising:
a bitstream generator to generate a scalable video bitstream; and
a bitstream transmitter to transmit the generated scalable video bitstream to a streaming server,
wherein data of layers in the scalable video bitstream is stored in an encoder source buffer included in the streaming server, in an order of frames, and in an order from a lowest layer to a highest layer.

10. The real-time encoding system of claim 9, wherein the data of the layers is extracted from the encoder source buffer based on a playback time, and the extracted data is buffered for each of the layers in buffers of a plurality of subgroup transmitters that are further included in the streaming server.

11. A bitstream transmission method for providing a scalable video bitstream for each multicast group, the bitstream transmission method comprising:
receiving a scalable video bitstream and storing the received scalable video bitstream in an encoder source buffer; and
receiving data of different layers in the stored scalable video bitstream from the encoder source buffer, packetizing the received data, and transmitting the packetized data to a terminal.

12. The bitstream transmission method of claim 11, wherein the receiving of the scalable video bitstream comprises storing the data of the different layers in the scalable video bitstream, in an order of frames, and in an order from a lowest layer to a highest layer.

13. The bitstream transmission method of claim 11, wherein the receiving of the data comprises extracting data of a required layer from the encoder source buffer, based on a playback time, and storing the extracted data.

14. The bitstream transmission method of claim 11, wherein the receiving of the data comprises transmitting the packetized data to a subgroup receiver that receives data of layers corresponding to the packetized data, among a plurality of subgroup receivers included in the terminal.

15. A bitstream transmission method for receiving a scalable video bitstream for each multicast group, the bitstream transmission method comprising:
receiving, from a streaming server, data of a corresponding layer among data of layers in a scalable video bitstream; and
decoding the received data,
wherein the data of the layers is divided for each of the layers, when a plurality of subgroup transmitters each extract the data of the layers from an encoder source buffer and buffer the extracted data, wherein the subgroup transmitters and the encoder source buffer are included in the streaming server, and
wherein the receiving comprises receiving data of a required layer from a subgroup transmitter that buffers the data of the required layer among the plurality of subgroup transmitters.

16. The bitstream transmission method of claim 15, wherein the data of the layers is extracted from the encoder source buffer based on a playback time, and the extracted data is stored in a buffer of a corresponding subgroup transmitter.

17. The bitstream transmission method of claim 15, wherein the scalable video bitstream is generated by a real-time encoder, is transmitted to the streaming server, and is stored in the encoder source buffer in an order of frames, and in an order from a lowest layer to a highest layer.

18. The bitstream transmission method of claim 15, wherein the decoding comprises decoding data of different layers received from the plurality of subgroup receivers, and generates videos that differ from each other in at least one of a resolution, a frame rate, and an image quality.

19. A bitstream transmission method for generating a scalable video bitstream, the bitstream transmission method comprising:
generating a scalable video bitstream; and
transmitting the generated scalable video bitstream to a streaming server,
wherein data of layers in the scalable video bitstream is stored in an encoder source buffer included in the streaming server, in an order of frames, and in an order from a lowest layer to a highest layer.

20. The bitstream transmission method of claim 19, wherein the data of the layers is extracted from the encoder source buffer based on a playback time, and the extracted data is buffered for each of the layers in buffers of a plurality of subgroup transmitters that are further included in the streaming server.
